(19) United States
(12) Patent Application Publication
(10) Pub. No.: US 2004/0203483 A1
(43) Pub. Date: Oct. 14, 2004

(54) Interface transceiver power mangagement method and apparatus

(75) Inventors: Juan-Antonio Carballo, Austin, TX (US); David William Boerstler, Round Rock, TX (US); Jeffrey L. Burns, Austin, TX (US)

Correspondence Address: Andrew M. Harris, Weiss, Moy & Harris, P.C., 4204 North Brown Ave., Scottsdale, AZ, 85251-3914, US

(73) Assignee: International Business Machines Corporation, Armonk, NY

(21) Appl. No.: 10/289,777

(22) Filed: Nov. 7, 2002

(51) Int. Cl. H04B 1/40

(52) U.S. Cl. 455/88; 455/127.1

(57) ABSTRACT

An interlace transceiver power management method and apparatus reduces power consumption when interface conditions will support a transceiver having reduced complexity. Characteristics of the receiver and/or transmitter are adjusted in conformity with one or more selection signals. An interface quality measurement circuit may provide the selection signal, so that the transceiver complexity is adjusted in response to measured interface conditions or an external pin or register bit may be coupled to a select input. The receiver complexity adjustment may include the receiver sampling depth, window width, resolution or equalization complexity or other characteristic having an impact on receiver circuit power consumption. The transmitter complexity may be equalization, transmitter power or other characteristic having an impact on transmitter circuit power consumption. The select signal may be communicated from one transceiver to another, so that the power consumption at a remote location is determined by local measurement or programming.

### BACKGROUND OF THE INVENTION

1. Technical Field

The present invention relates generally to communication link circuits, and more particularly, to transmitters and/or receivers having selectable complexity and power consumption.

2. Description of the Related Art

Interfaces between present-day system devices and also between circuits have increased in operating frequency and complexity. In particular, high speed serial interfaces require data/clock extraction, jitter reduction, phase correction, error correction, error recovery circuits and equalization circuits that can become very complex, depending on the performance requirements of a particular interface. As the above-mentioned circuits become more complex, they have an increasingly large proportion of digital logic and the overall amount of digital logic employed in both receiver and transmitter circuits has increased substantially.

Due to limited design resources and the need to satisfy the requirements of multiple interface applications, customers and channel conditions, transmitters and receivers within above-described interfaces are typically designed for the worst-case bit error rates and environmental conditions, leading to relatively complex receivers and high power transmitters. As a result, it is not always possible to provide a receiver that is not more complex than necessary when a high channel quality is available.

The complexity of the above-mentioned receivers increases as the worst-case error rates and interface conditions deviate from the ideal. Complexity of the transmitter may also increase due to the use of digital equalization circuits and error correction encoding. Power consumption and heat dissipation within interface circuits or systems silicon are thus increased over that which is necessary, in order to meet performance requirements over all anticipated interface conditions.

It is therefore desirable to provide an interface transceiver having reduced power consumption.

The objective of providing an interface transceiver having reduced power consumption is achieved in a method and apparatus. An interface receiver includes one or more processing blocks having selectable power consumption configurations. The characteristics of the receiver and/or transmitter may be adjusted in response to a select input, permitting the transceiver power consumption and complexity to be tailored to interface requirements.

Transmitter power and/or equalization filtering may be reduced if interface conditions permit. Receiver window width, phase correction resolution, error correction depth and equalization filter size, as well as sample memory size may all be adjusted to reduce power consumption and complexity.

The selection process may be programmable by a logic connection, register bit or via a signal from an interface quality measurement circuit. A remote transceiver may also be power-managed at the other end of the interface by transmitting a control signal to the remote transceiver.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of an illustrative embodiment when read in conjunction with the accompanying drawings, wherein like reference numerals indicate like components, and:

FIG. 1 is a block diagram of transceivers connected by an interface in accordance with an embodiment of the invention.

FIG. 2 is a block diagram of a transceiver in accordance with an embodiment of the invention.

FIG. 3 is a schematic diagram of exemplary power management circuits in accordance with embodiments of the invention.

FIG. 4 is a flowchart depicting a method in accordance with an embodiment of the invention.

### DESCRIPTION OF ILLUSTRATIVE EMBODIMENT

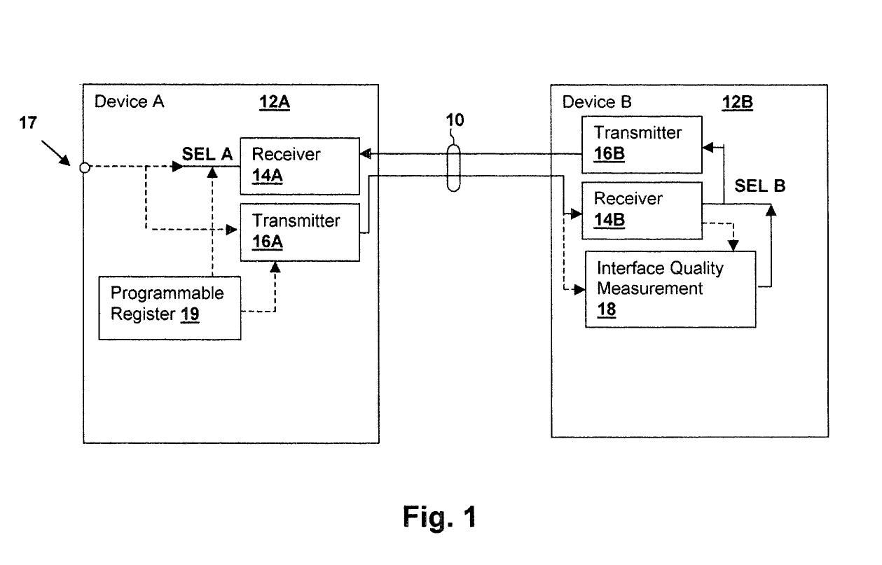

With reference now to the figures, and in particular with reference to FIG. 1, there is depicted a block diagram of transceivers 12A and 12B connected by an interface or channel 10 in accordance with an embodiment of the invention. Transceivers 12A, 12B may be located within a device such as a computer peripheral, a computer system, or within integrated circuits interconnected within a system. Interface 10 may be a single two wire bi-directional interface as depicted, or may be a full-duplex single wire interface or a bus having multiple transceivers in a half-duplex or full-duplex configuration. Transceivers 12A and 12B connected to interface 10 each using a receiver 14A and 14B and a transmitter 16A and 16B, but the present invention is applicable to receivers and/or transmitters and it should be understood that a receiver or transmitter in accordance with an embodiment of the invention may be incorporated in devices for connection to any of the above-specified types of interface 10, as well as other forms of electrical signal interconnection.

The interface circuits (transmitters 16A,16B and receivers 14A, 14B) of the present invention incorporate select inputs SELA and SELB that reduce the complexity of the connected interface circuits, in order to reduce power consumption. Circuit blocks having lower power consumption may be switched in as alternatives or circuit blocks may be selectively disabled to reduce the number of gates, storage circuits, and/or transitions that occur when processing signals within interface circuits 14A-B and/or 16A-B. Analog circuit blocks within interface circuits may also be selectively simplified or eliminated 14A-B and/or 16A-B when channel conditions permit.

Thus, the above-described interface circuits provide a selectable power consumption that can be used to provide lower power usage and dissipation within transceivers 12A and 12B, when channel conditions are good, while maintaining low bit error rates (BERs) using a higher power consumption state when channel conditions are poor. The selection of power consumption states via select input SELA may be hard-wired or externally programmed using an external signal terminal 17 or may be programmed using a bit register 19 within transceiver 12A. Receiver 14A, transmitter 16A or both may be controlled by one or more selection signals, for example, multiple bits may be provided for each of transmitter 16A and receiver 14A so that power consumption may be very finely traded off for receiver processing power or transmitter signal strength, etc. Alternatively, a single bit or external terminal may be used to set a single binary power consumption selection for both transmitter 16A and receiver 14A.

Transceiver 12A is an example of a transceiver having external selection via register programming or external connection. As such, it is very useful in integrated circuits and systems, including computer systems, communication systems, or peripherals where external terminal 17 can be hard-wired depending on the application (e.g., known short shielded cable length attached to a peripheral dictates a high channel quality or connection of two transceivers on a high-quality circuit board also dictates high channel quality).

Transceiver 12B is an example of a transceiver having automatic channel-quality-based complexity selection in response to a measurement performed by interface quality measurement block 18, which may be an eye-diagram circuit, an error detection circuit or other mechanism for detection that the channel quality is less than a desired threshold. Select signal SEL B is provided by an output of interface quality measurement block 18 and automatically selects higher or lower receiver and/or transmitter complexity in conformity with the measured channel quality.

Another type of transceiver power consumption control is provided by an interface link wherein a register such as programmable register 19 may be set via reception of a command code sent over interface 10 and received by a receiver such as receiver 14A. The interface link control is very useful where the receiver and transmitter characteristics must match (such as when the select signal changes an error-correction length or when matching filters are used at each end of interface 10). Interface link control is also useful for informing a transceiver about channel conditions when the transceiver being programmed has no ability to determine the channel quality or does not have information regarding channel conditions (such as cable length).

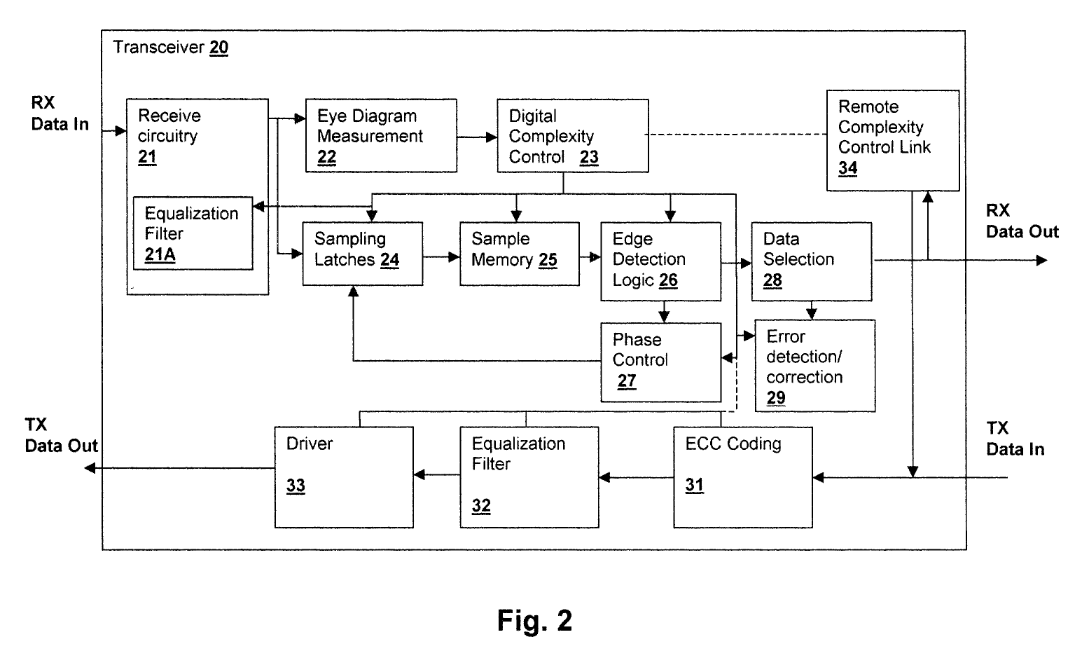

Referring now to FIG. 2, details of a transceiver 20 in accordance with an embodiment of the invention are depicted. An interface signal is received at RX Data In and provided to a receiver circuit 21 that may contain an equalization filter 21A or may not. The output of receiver circuit 21 is generally presented to a series of sampling latches 24 and data is provided from sample latches 24 to a sample memory 25. Sampling latches 24 and sample memory 25 are used to “oversample” the received signal so that the edges of the signal can be determined with more accuracy in the face of high frequency jitter.

Edge detection logic 26 detects one or both edges of the received signal (which typically contains clock and data bits) and provides early/late information to phase control 27, which in turn controls sampling latches 24 to compensate for low-frequency jitter. Data is extracted by data selection 28 and error detection and correction circuits 29 may be employed to further minimize the BER of the received signal.

A digital complexity control circuit 23 provides one or more control signals to various of the above-described blocks to select a higher or lower power consumption depending on the channel requirements. The selection may be static or static/programmable as described above with respect to FIG. 1, or dynamic based upon an output of eye measurement diagram circuit 22 (or other suitable indicator of channel quality). Eye measurement diagram provides a measurement of the signal quality output of receive circuitry 21, giving an indicator of the impact of jitter on BER. The power consumption of the various circuits is tailored by reducing the overall complexity or direct power levels used by the circuits and may be controlled by individual control bits or a single control bit. For example, the number of sampling latches 24 employed is proportional to the power consumption of the sampling 24 latches block, the size of sample memory 25, the resolution of the phase control circuit 27 and edge detection logic 27, and the depth of error correction and detection 29 are all proportional to their power consumption. Any or all of the above-listed circuit blocks may have selectable power consumption and may be controlled independently or together at one or more power consumption levels.

The transmitter portion of transceiver 20 comprises an optional error correction coding circuit 31, an optional equalization filter 32 and a driver 33 for transmitting data on the interface TX Data Out. Digital complexity control 23 may also control the complexity of the transmitter circuits, such as driver 33 current, equalization filter 32 length or ECC coding 31 depth.

Digital complexity control 23 is also shown coupled to an optional remote complexity control link 34 for controlling power consumption. A command received at RX Data In can be received and decoded to control the complexity of the circuit blocks within transceiver 20 via the output of data selection 28. Digital complexity control is also shown coupled to the transmitter circuits for transmitting complexity control information to a remote transceiver. These remote control features are optional and their implementation depends on whether it is possible and desirable to send and receive control information over the interface channel.

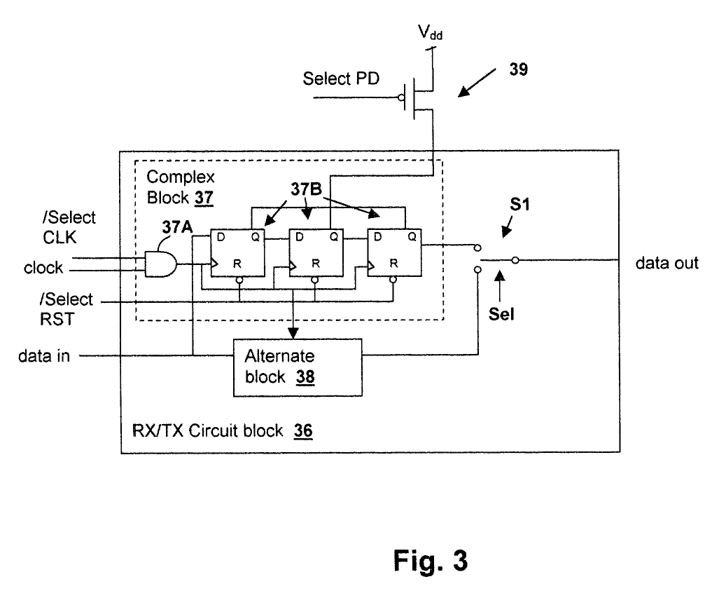

Referring now to FIG. 3, techniques for controlling power consumption within the interface circuits of FIG. 2 is illustrated. Select PD can be used to control power supplied to blocks having power supplies connected through power control transistor 39 or an equivalent device, /Select CLK disables a clock via NAND gate 37A or equivalent device which serves as a clock disable circuit, and /Select RST holds registers 37B in a reset condition. Sel selects between complete block 37 and alternate block 38 (which generally will be disabled when complex block 37 circuits are enabled). The circuits shown in FIG. 3 are illustrative and are not typical of the transceiver circuits described above, which contain a greater number of registers and gates. But the techniques illustrated can be applied together or selectively to disable power consumption within the complex portions of the above-described receivers. Since eliminating clocks or state changes in modern digital circuits may have the same effect on power consumption as removing power as long as leakage paths are not present, any of the above techniques may be be sufficient. Another power reduction mechanism is the simplification of state machine circuits, wherein alternative state machines may be selected similarly to the selection between complex block 37 and alternate block 38 or by disabling some of the state registers (and changing the combinatorial feedback logic accordingly).

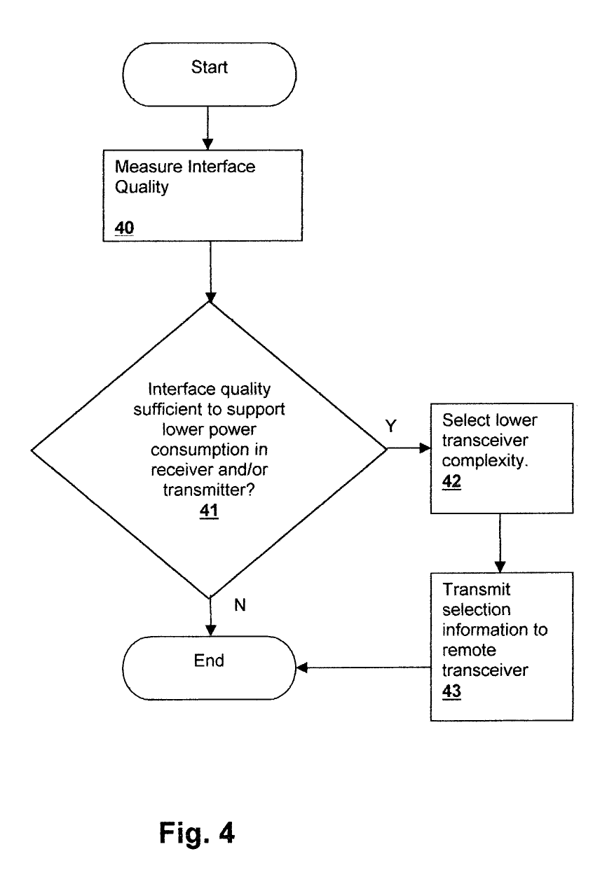

Referring now to FIG. 4, a control method in accordance with an embodiment of the present invention is shown in a flowchart. First, interface channel quality is measured (step 40) and if the interface channel quality is sufficient to support a lower power consumption state within the transceiver (decision 41), the lower transceiver complexity is selected (step 42) and the selection information is optionally transmitted over the interface to any connected remote transceivers (step 43). The above-illustrated method includes optional steps 40 and 43, to illustrate a complete functionality including autonomic measurement and optional remote control of remote transceivers. However, it should be understood that those optional steps are not necessary for the practice of the invention.

While the invention has been particularly shown and described with reference to the preferred embodiment thereof, it will be understood by those skilled in the art that the foregoing and other changes in form, and details may be made therein without departing from the spirit and scope of the invention.

What is claimed is:

1. A transceiver for interconnecting electronic devices, comprising:
at least one interface circuit having selectable power consumption coupled to one or more interface signals;
a select input coupled to said at least one interface circuit for receiving a selection signal, whereby a level of complexity of said one or more interface circuits is selected by a logic state of said select input.

2. The interface transceiver of claim 1, wherein said at least one interface circuit comprises a transmitter circuit.

3. The interface transceiver of claim 2, wherein said transmitter circuit comprises an digital equalization filter coupled to said select input and having a selectable number of multiple taps, and wherein said number of said multiple taps is selected in conformity with said logic state of said select input.

4. The interface transceiver of claim 2, wherein said transmitter circuit has variable power output, and wherein a level of said variable power output is selected in conformity with said logic state of said select input.

5. The interface transceiver of claim 1, wherein said at least one interface circuit comprises a receiver circuit.

6. The interface transceiver of claim 5, wherein said receiver circuit comprises an digital equalization filter having multiple taps and coupled to said select input, and wherein said number of said multiple taps is selected in conformity with said logic state of said select input.

7. The interface transceiver of claim 5, wherein said receiver circuit comprises a phase control circuit having a selectable resolution and coupled to said select input, and wherein said selectable resolution is selected in conformity with said logic state of said select input.

8. The interface transceiver of claim 5, wherein said receiver circuit comprises a sample memory for processing said one or more interface signals and coupled to said select input, said sample memory having a selectable active size, and wherein said selectable active size is selected in conformity with said logic state of said select input.

9. The interface transceiver of claim 5, wherein said receiver circuit comprises a signal processing block having a selectable sampling window for processing bits received from one of said interface signals and coupled to said select input, and wherein said selectable sampling window is selected in conformity with said logic state of said select input.

10. The interface transceiver of claim 5, wherein said receiver circuit comprises an error-correction circuit having a selectable correction depth and coupled to said select input, and wherein said selectable correction depth is selected in conformity with said logic state of said select input.

11. The interface transceiver of claim 1, further comprising an interface quality measurement circuit, and wherein said select input is coupled to an output of said interface quality measurement circuit.

12. The interface transceiver of claim 11, further comprising a communication link for transmitting an output of said quality measurement circuit to a remote transceiver over said one or more interface signals.

13. The interface transceiver of claim 11, wherein said at least one interface circuit comprises a transmitter circuit, wherein said transmitter circuit comprises an digital equalization filter coupled to said select input and having a selectable number of multiple taps, and wherein said number of said multiple taps is selected in conformity with said logic state of said select input.

14. The interface transceiver of claim 11, wherein said at least one interface circuit comprises a transmitter circuit, wherein said transmitter circuit has variable power output, and wherein a level of said variable power output is selected in conformity with said logic state of said select input.

15. The interface transceiver of claim 11, wherein said at least one interface circuit comprises a receiver circuit, wherein said receiver circuit comprises an digital equalization filter having multiple taps and coupled to said select input, and wherein said number of said multiple taps is selected in conformity with said logic state of said select input.

16. The interface transceiver of claim 11, wherein said at least one interface circuit comprises a receiver circuit, wherein said receiver circuit comprises a phase control circuit having a selectable resolution and coupled to said select input, and wherein said selectable resolution is selected in conformity with said logic state of said select input.

17. The interface transceiver of claim 11, wherein said at least one interface circuit comprises a receiver circuit, wherein said receiver circuit comprises a sample memory for processing said one or more interface signals and coupled to said select input, said sample memory having a selectable active size, and wherein said selectable active size is selected in conformity with said logic state of said select input.

18. The interface transceiver of claim 11, wherein said at least one interface circuit comprises a receiver circuit, wherein said receiver circuit comprises a signal processing block having a selectable sampling window for processing bits received from one of said interface signals and coupled to said select input, and wherein said selectable sampling window is selected in conformity with said logic state of said select input.

19. The interface transceiver of claim 1, further comprising a communication link for transmitting a state of said select input to a remote transceiver over said one or more interface signals.

20. The interface transceiver of claim 1, wherein said at least one interface circuit includes a plurality of alternate circuit blocks, wherein a first one of said circuit blocks is disabled in response to said logic state of said select input, and wherein a second one of said alternate circuit blocks is enabled in response to said logic state of said select input.

21. The interface transceiver of claim 1, wherein said at least one interface circuit includes a state machine, wherein a complexity of said state machine is adjusted in conformity with said logic state of said select input.

22. The interface transceiver of claim 1, wherein said select input is coupled to a clock disable circuit within said at least one interface circuit, whereby said at least one interface circuit blocks is disabled by disabling a clock input to said at least one interface circuit.

23. The interface transceiver of claim 1, wherein said select input is coupled to a reset input of said at least one interface circuit, whereby said at least one interface circuit is disabled by holding said at least one interface circuit in a reset condition in response to said logic state of said select input.

24. The interface transceiver of claim 1, wherein said select input is coupled to a power supply control circuit for controlling a power supply input of said at least one interface circuit, whereby said at least one interface circuit is disabled by removing power in response to said logic state of said select input.

25. A method of controlling power consumption in an interface transceiver, comprising:
receiving an indication of that power consumption of said interface transceiver may be reduced; and
in response to said receiving, selecting a complexity of said receiver.

26. The method of claim 25, further comprising:
measuring a quality of an interface signal coupled to said interface transceiver;
determining whether or not said quality is above a threshold level; and
in response to determining that said quality is above a threshold level, generating said indication.

27. The method of claim 25, further comprising communicating a state of said indication to a remote transceiver.
